(19) United States
(12) Patent Application Publication
(10) Pub. No.: US 2008/0198833 A1
(43) Pub. Date: Aug. 21, 2008

(54) SYSTEM AND METHOD OF REAL-TIME SCHEDULING AND CONTROL FOR MULTI-HOP ZERO-QUEUE DISTRIBUTED SYSTEMS

(75) Inventor: WEI K. TSAI, IRVINE, CA (US)

Correspondence Address: FRANK F. TIAN, 331-4A THIRD AVENUE, LONG BEACH, NJ, 07740, US

(73) Assignee: IST INTERNATIONAL INC., ALISO VIEJO, CA (US)

(21) Appl. No.: 12/033,051

(22) Filed: Feb. 19, 2008

Related U.S. Application Data
(60) Provisional application No. 60/890,803, filed on Feb. 20, 2007.

(51) Int. Cl. H04J 3/00

(52) U.S. Cl. 370/345

(57) ABSTRACT

A method for communication between at least 3 modes is provided. The method comprises the step of scheduling transmissions to minimize the average time between two consecutive transmissions from a node using linear programming.

### CROSS-REFERENCE TO OTHER APPLICATIONS

The following applications of common assignee and filed on the same day herewith are related to the present application, and are herein incorporated by reference in their entireties:

U.S. Provisional Patent Application No. 60/852,644 with attorney docket number ______.

### REFERENCE TO RELATED APPLICATIONS

This application claims an invention which was disclosed in Provisional Application No. 60/890,803, filed Feb. 20, 2007 entitled “SYSTEM AND METHOD OF REAL-TIME SCHEDULING AND CONTROL FOR MULTI-HOP ZERO-QUEUE DISTRIBUTED SYSTEMS”. The benefit under 35 USC § 119(e) of the United States provisional application is hereby claimed, and the aforementioned application is hereby incorporated herein by reference.

### FIELD OF THE INVENTION

The present invention is a continuation in part of the provisional filing, 60/852,644, which is hereby incorporated herein by reference. The field of invention is identical to that of the cited filing.

### BACKGROUND OF THE INVENTION

The background of the present invention is the same as that of the filing, 60/852,644.

To facilitate the description of the present invention, the class of multiple-access communication systems with a single broadcast medium is assumed to be the applicable systems. This assumption is in no way a restriction on the applicability of the present invention; multiple-access communication systems are only used as a vehicle to describe the present invention in a context, and to avoid verbiage needed in a general setting.

The purpose of the present disclosure is to provide additional aspects of the disclosure in the co-pending provisional filing, 60/852,644, and an improvement therefore. The previous disclosure focuses on the infrastructure mode operations of WiFi networks; while the present invention focuses on ad-hoc or mesh mode of operations relating to WiFi networks.

Therefore, the present invention will focus on wireless communications over multiple hops vs. focuses on single hop communications.

### SUMMARY OF THE INVENTION

A method comprising the step of scheduling transmissions to minimize the average time between two consecutive transmissions from a node using linear programming is provided.

It is an object of the present invention to provide a system and method of scheduling transmissions to minimize the average time between two consecutive transmissions from the same node.

### BRIEF DESCRIPTION OF THE DRAWINGS

The above and other objects and features in accordance with the present invention will become apparent from the following descriptions of preferred embodiments in conjunction with the accompanying drawings, and in which:

FIG. 1 is an example of the linear ladder problem, optimal schedule D=2Ts.

FIG. 2 is an example of showing simultaneous transmissions from two nodes causes no loss of data.

FIG. 3 is an example of the 2-node case, wherein a gap is needed to prevent collisions at the receivers.

FIG. 4 is an example of a simple change of ordering, the original directional cycle disappears

FIG. 5 is an example of Parallel ordering does not induce interlace, thus inefficient in throughput.

FIG. 6 is an example of the graph of D as a function of d for the 3-node case.

FIG. 7 is an example of the timing diagram for scheduling for d=2Ts for the 3-node case.

FIG. 8 is an example of the analysis diagram for scheduling as d increases from 0 to Ts/3 for the 3-node case.

FIG. 9 is an example of the analysis diagram for scheduling as d increases from Ts/3 to Ts for the 3-node case.

FIG. 10 is an example of the timing diagram for scheduling for d=2Ts for the 3-node case.

FIG. 11 is an example of a system diagram of the present invention.

### DETAILED DESCRIPTION OF THE PRESENT INVENTION

Certain embodiments as disclosed herein provide for a MAC module that is conFig.d to be deployed in a wireless communication device to facilitate multi-hop wireless network communications over high bandwidth wireless communication channels based on UWB, OFDM, 802.11/a/b/g, among others. In one embodiment, the nodes involved in the multi-hop wireless communications are arranged in a mesh network topology. For example, one method as disclosed herein allows for the MAC module to determine the network topology by parsing beacon signals received from neighbor nodes within communication range and establish high bandwidth communication links with those nodes that are within range to provide a signal quality that supports high bandwidth communication. For applications that require a certain level of quality of service, the methods herein provide for establishing a multi-hop end-to-end route over the mesh network where each link in the route provides the necessary level of signal quality.

After reading this description it will become apparent to one skilled in the art how to implement the invention in various alternative embodiments and alternative applications. To facilitate a direct explanation of the invention, the present description will focus on an embodiment where communication is carried out over a UWB network, although the invention may be applied in alternative networks including 802.11, 802.15, 802.16, worldwide interoperability for microwave access (“WiMAX”) network, wireless fidelity (“WiFi”) network, wireless cellular network (e.g., wireless wide area network (“WAN”), Piconet, ZigBee, IUP multimedia subsystem (“IMS”), unlicensed module access (“UMA”), generic access network (“GAN”), and/or any other wireless communication network topology or protocol. Additionally, the described embodiment will also focus on a single radio embodiment although multi-radio embodiments and other multiple input multiple output (“MIMO”) embodiments are certainly contemplated by the broad scope of the present invention. Therefore, it should be understood that the embodiment described herein is presented by way of example only, and not limitation. As such, this detailed description should not be construed to limit the scope or breadth of the present invention as set forth in the appended claims.

Before addressing details of embodiments described below, some terms are defined or clarified. As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of the “a” or “an” are employed to describe elements and components of the invention. This is done merely for convenience and to give a general sense of the invention. This description should be read to include one or at least one and the singular also includes the plural unless it is obvious that it is meant otherwise.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

In a sense, the present invention presents a fundamental system and method for scheduling multi-hop transmissions in a broadcast medium.

In the application system, data frames arriving at the same node at the same time is considered lost; however, simultaneous transmissions from one node to different nodes are possible (called multicast or broadcast), while a node cannot transmit and receives at the same time (half-duplex).

The symbols used in this disclosure: Ts is the transmission time for a data frame; d is the delay between two nodes; and D is the period between two repeating transmissions from the same node to the same set of nodes.

In the present disclosure, the description starts on the case when the delay from a sender to a receiver is constant, the general case wherein the delay is different or variable is described later.

The present disclosure focuses on the unicast case, which is defined as a transmission from one node to exactly one node. Due to this assumption, each node can have at most one transmission to another node. If a node can have two or more transmissions, then these transmissions can be scheduled to be at the same time, making the problem a multicast problem.

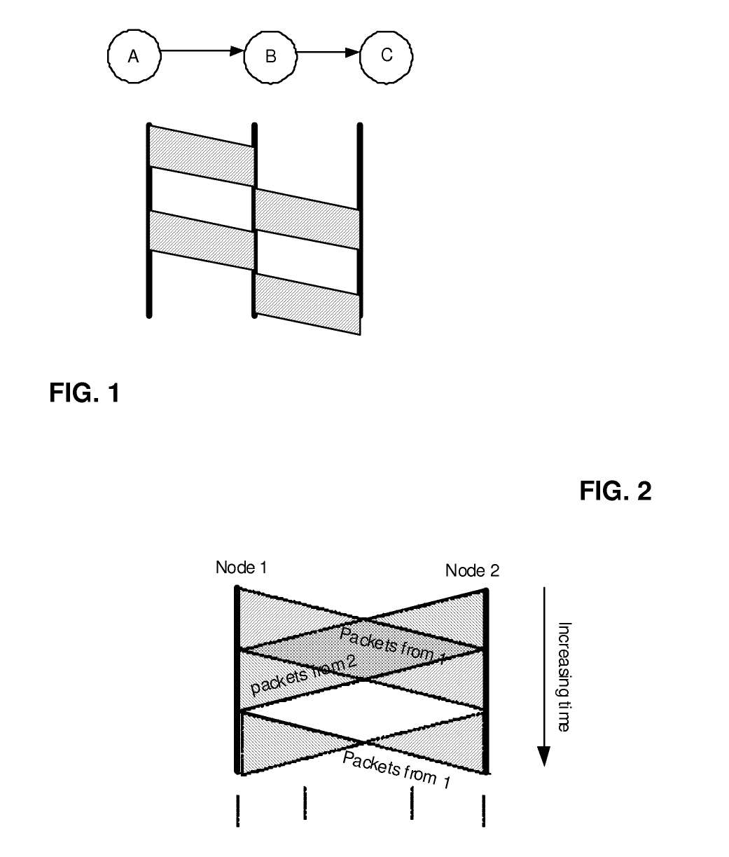

A basic scheduling problem is that of the linear ladder problem: a linear sequence of nodes that a node is to forward successive data frames to the next node (see FIG. 1).

For the above problem, the optimal schedule is to pipeline the transmissions.

The periodic duration for all nodes is D=2 Ts.

If all nodes are always busy in sending and receiving data frames without any gaps, then there is no way to further shorten the period D. As D is minimized, the schedule is considered to be optimal.

There exists a mathematical proof that for the linear ladder problem, the pipelined schedule of sending and receiving alternatively without any gaps is optimal in minimizing D.

The reason for the number “2” in the formula is that each intermediate node must repeat receiving and sending without a gap. Under this schedule, a node must wait for the current transmission (1 Ts) and the reception from the previous node (1 Ts) before it can send again.

Due to this result, a general multi-hop transmission schedule problem can be simplified by pruning all the branches in the network transmission diagram. A branch is defined to be a linear ladder sub-problem in the network transmission schedule problem.

Therefore, if one solves a network transmission schedule problem with cycles, the core difficulty has been removed. In what follows, the present disclosure focuses on scheduling transmissions in cycle topologies.

There is an important scheduling technique that is overlooked by most if not all WiFi scheduling and control schemes. This technique is based on the fact that the Maxwell equations governing the wireless propagations of signals are linear. Therefore, even though two signals may collide in the mid air, as long as two signals do not arrive at the same time and at the same place, the integrity of the signals are retained.

In accordance with the present invention, a first principle of WiFi scheduling is to schedule simultaneous transmissions whenever there are no collisions at the intended receivers for intended data frames. A simple example obeying this principle is provided in FIG. 2.

To facilitate the description of the present invention, the concept of network transmission diagram (see the incorporated references) is useful.

A network transmission diagram is constructed as follows: If there is a transmission from node 1 to node 2, then add a directed arc from node 1 to node 2. All nodes that have transmissions, either on the sending or receiving side, must be included in the diagram.

Note that the abstract definition of network transmission diagram conveys the concept of topologically constrained traffic patterns.

There exist three degrees of freedom in a schedule: (1) begin time of each transmission, (2) duration of each transmission, and (3) guard time (gap) inserted before and/or after a transmission. A schedule is said to be feasible if the schedule does not cause any collisions at all intended receivers for intended data frames. Note that a feasible schedule is collision-free by definition.

To further describe scheduling schemes associated with the present invention, it is necessary to differentiate two cases: (1) the transmission time for a data frame is larger than the minimum sender-to-receiver delay, and (2) the transmission time for a data frame is smaller than the minimum sender-to-receiver delay. Case (1) corresponds to Ts>d; while the second case, corresponds to Ts<=d.

The second case Ts<=d represents a very interesting case. This case corresponds to the situation wherein the delay between two nodes become large enough, that the one single transmission time is less than the delay between a sender and a receiver. A very simple design by adjusting the transmission time of one data frame to match exactly the delay will generate a schedule with zero gaps. The simple schedule is as follows: All nodes send at the same time. Then all nodes receive their respective data frames, after the same fixed sender-to-receiver delay. Then the schedule repeats.

The above schedule is optimal for all networks wherein the sender-to-receiver delays are more or less the same, and that each node has exactly one transmission and one reception of data frame. For the general case when the 1-way delays are quite different, a systematic procedure to design the schedule is provided later in the present disclosure.

An ordered transmission diagram is defined as a network transmission diagram with all its directed arcs partially ordered. Each partial order on a transmission diagram maps to a set of schedules in the sense that two transmissions happen in sequence if the two corresponding arcs can be compared in the order.

An ordered transmission diagram is said to have an ordered cycle if according to the partial order, a sequence of directed arcs in the diagram forms a directed cycle.

In accordance with the present invention, then it can be proofed that any feasible ordered transmission diagram without an undirected (the direction of a transmission is ignored) cycle can be scheduled without a guard time (guard time=0). Thus, such a schedule is a most efficient schedule in the sense that no time is wasted in the communication medium.

In accordance with the present invention, there exists a mathematical proof that if a network transmission diagrams contains at least an ordered cycle, then it is impossible to generate a schedule with guard time=0.

Based on the above results, the most interesting question that arises is: If the network transmission diagram contains an unordered cycle but not a directed cycle, what conclusion can be drawn?

In accordance with the present invention, the answer to the above question is: It depends on the delays. It is possible to generate zero-gap schedules if the delays between nodes satisfy a certain condition depending on the cycle length.

Because of the above results, if there is a directed cycle in the network transmission diagram, it is beneficial to re-order the transmissions so that the resulting transmission diagram contains zero directed cycle. Once all ordered cycles are broken, then it is possible to obtain zero guard time schedules. However, it is still not possible to guarantee zero guard time even when there is no ordered cycles in the transmission diagram. Fortunately, the present invention provides a method to order and schedule transmissions to minimize gaps, or equivalently the period D.

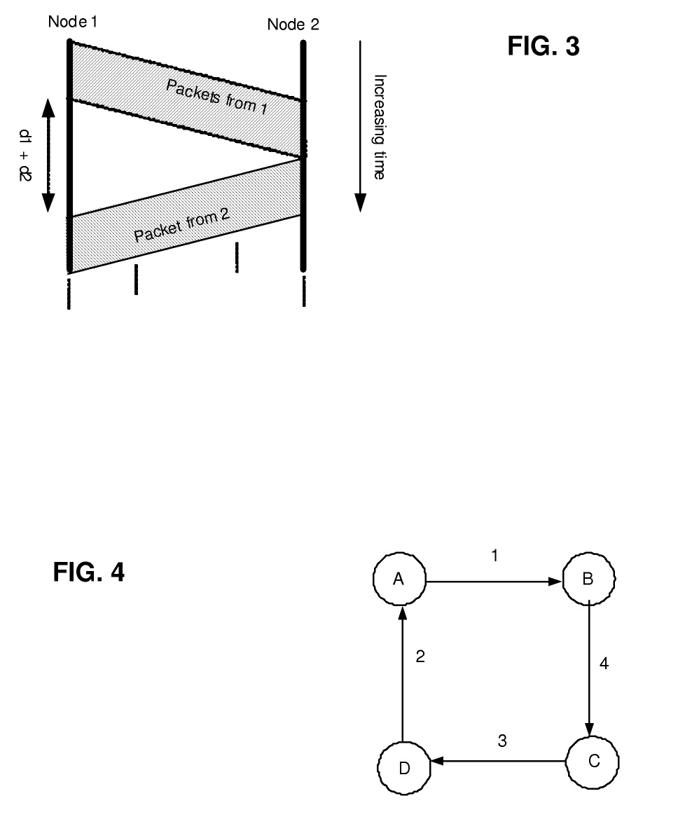

An example of impossibility to generate zero guard time scheduling is from FIG. 3. The question whether a zero guard time schedule is possible or not depend both on the cycle and the delays between nodes.

FIG. 4 shows an example that by simply changing the order of transmissions, the cycle disappear, and it is possible to schedule the transmissions with zero guard time when the delays between any two nodes are fixed at d=Ts/3.

In accordance with the present invention, there exists a mathematical proof that a best way to break an ordered cycle to minimize D is to do a reversed path ordering: Suppose the original ordering of transmissions in the cycle is: 1, 2, 3, . . . , n; wherein each number corresponds to a particular transmission from one node to another. Then the reverse path ordering is to replace 2 by n, 3 by n−1, and similarly for the rest of the transmissions. Therefore, if the original order of transmissions is: 1, 2, 3, 4, and 5; the reversed path ordering will be 1, 5, 4, 3, and 2. An example of reversed path ordering is provided in FIG. 4.

In what follows, the delays between any two nodes are assumed to be of the same constant, d. This assumption is used to simplify the mathematical formulas and derivations. It is in no way a restriction of the general system and method presented in the current disclosure.

The key concept in minimizing D is to introduce interlace. Since a schedule is by definition periodic, then a partial schedule that contains the transmission times for all nodes exactly once can be considered as the base schedule. A complete schedule is generated by repeating the base schedules infinitely into the future. However, for practical purposes, a complete or semi-complete schedule is generated by repeating the base schedules for a predetermined number of times. In every schedule, it is possible that gaps exist between busy periods of a node. In order to minimize D and maximize throughput, a general principle is to reduce the gaps to zero. Therefore, if a base schedule can be overlapped (interlaced) with a preceding or succeeding base schedule, it is possible to reduce the gaps to zero.

Let the nodes in a cycle be named as A, B, C, and etc., in the direction of the cycle. In what follows, the discussion will focus on a single cycle. Since the present invention focuses on unicast, there is exactly one transmission from each node in a base schedule.

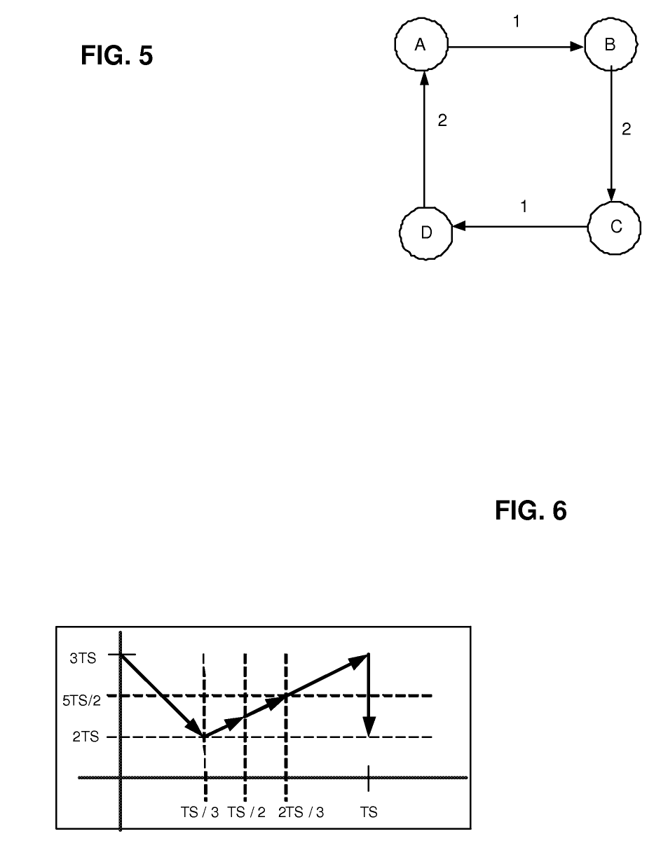

It is easy to check that if other ordering is used, for example, a parallel ordering in the 4-node case: A−>B and C−>D transmissions are assigned order 1, while B−>C and D−>A are assigned order 2, see FIG. 5. There is no way to efficiently utilize interlace, and a feasible schedule based on this partial ordering is worse than the reversed path ordering.

Let the start time of the transmission from node A be denoted by t_{A}^{s}, and the end time of the transmission from node A be denoted by t_{A}^{t}. The start and end times for other nodes are defined similarly.

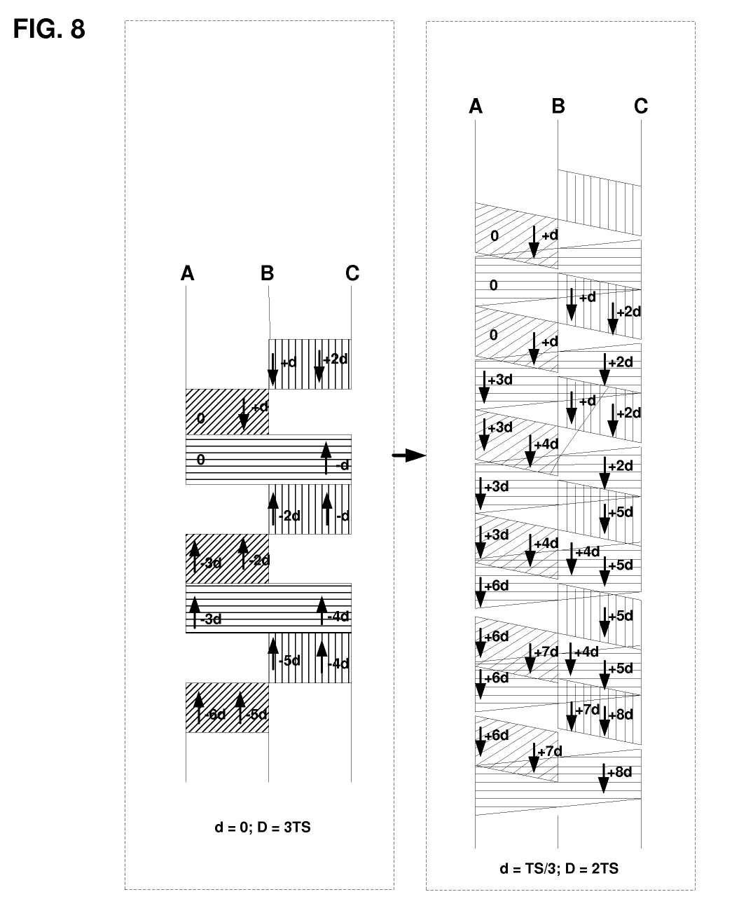

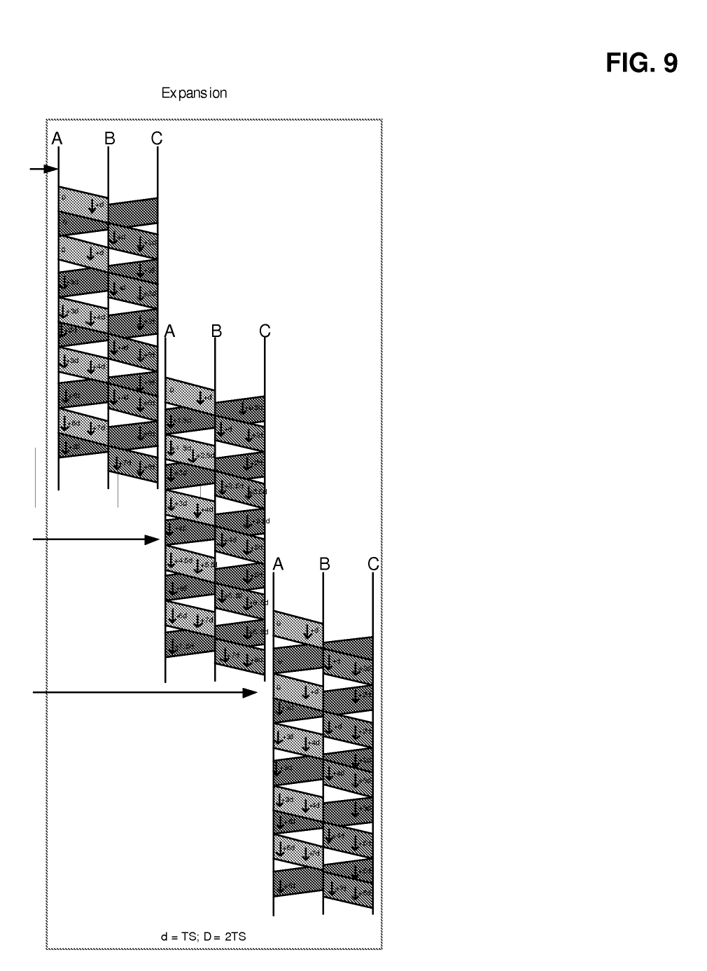

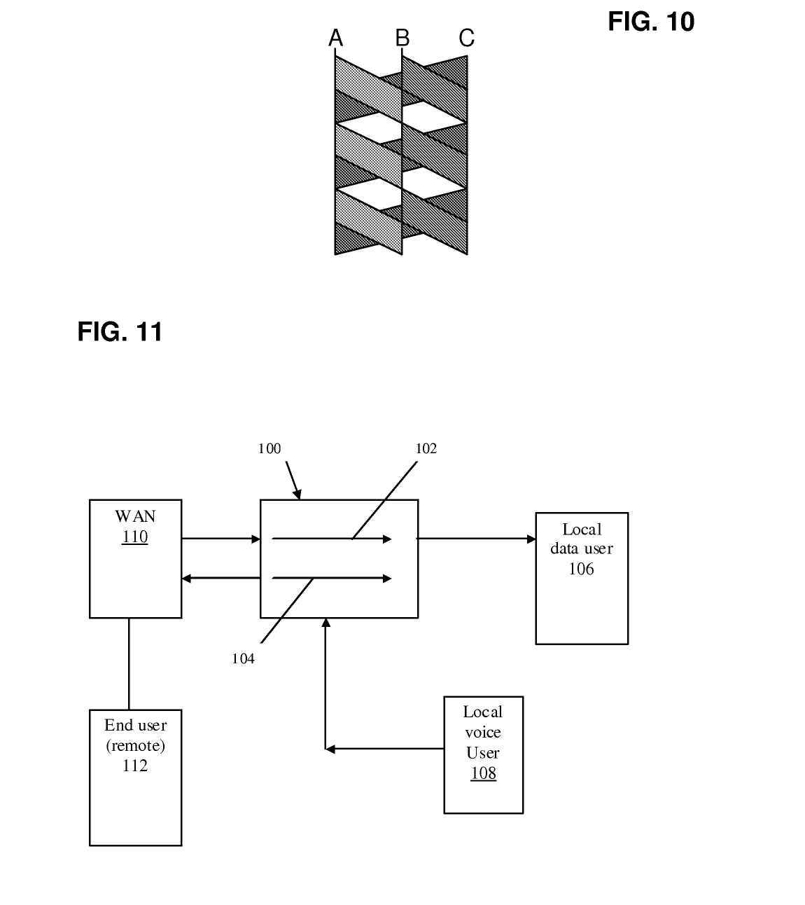

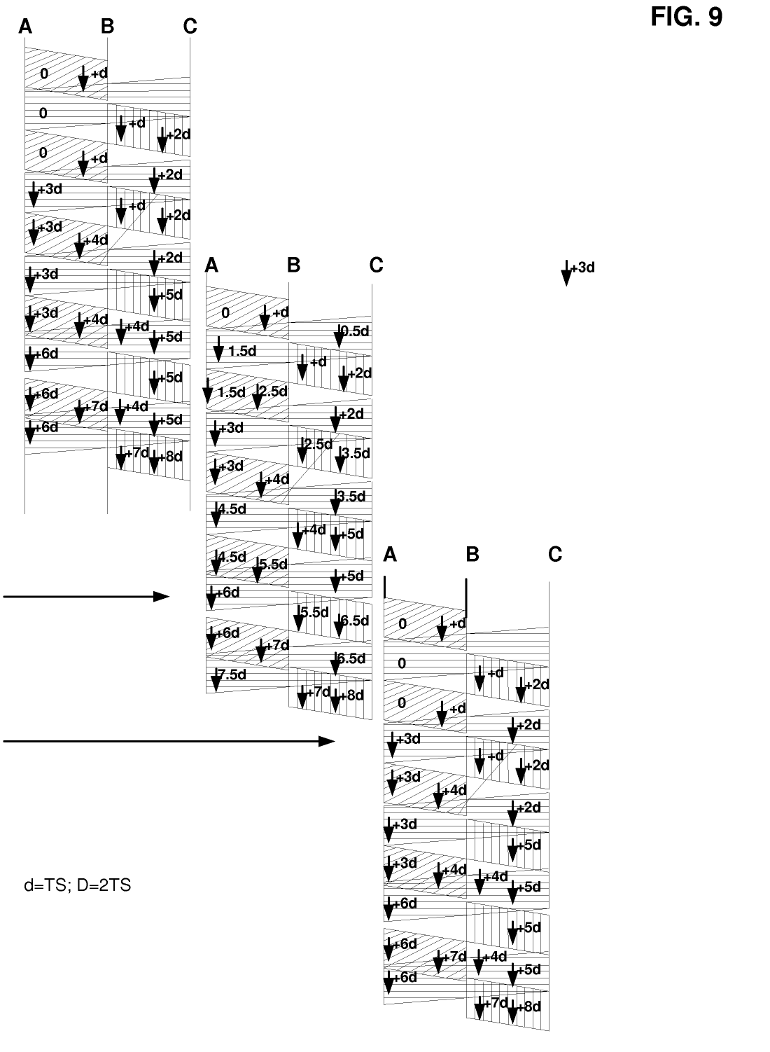

The period of a schedule is a bit tricky to define in terms of base schedule. The problem is that as base schedules are repeated, it is not necessary that the end condition of the nodes is the same as the initial condition of the nodes. Sometimes it takes a few repetitions to reproduce the identical initial and final condition. In this case, the time interval between two consecutive transmissions from the same node changes x times before it repeats again (if it takes x repetitions to generate the identical initial condition). For convenience, D is defined to be the average time between two consecutive transmissions from any node. FIGS. 8 and 9 illustrate the situations where simple repeating a base schedule does not restore the initial condition of the nodes.

In what follows, mathematical formulas are derived to compute the exact period D for the case of 3-node cycle. These derivations are provided to illustrate the kind of mathematical analysis that can be done to optimally schedule transmissions. The general n-node cycle case will be derived later in this disclosure.

There are two cases to consider: when d<Ts/3, and when d>=Ts/3. First consider the case when d<Ts/3:

d+t_{C}^{s}=t_{A}^{t} Equ. 1;

d+t_{B}^{s}=t_{C}^{t} Equ. 2;

D+d+t_{A}^{s}=t_{B}^{t} Equ. 3;

The first equation describes the condition that the start time of the current transmission from C plus delay must be precisely the same as the end time of the current transmission from A. This condition ensures that after the current transmission from A, no time is wasted before receiving the current transmission from C.

The first equation describes the condition that the start time of the current transmission from B plus delay must be precisely the same as the end time of the current transmission from C. This condition ensures that after the current transmission from C, no time is wasted before receiving the current transmission from B.

The third equation describes the condition that the next transmission from A plus delay must be exactly the same as end time of the transmission from B. This condition ensures that after the current transmission from B, no time is wasted before receiving the next transmission from A.

The above three equations are referred to as constraining equations for the 3-node case when d<=Ts/3.

Combining the constraining equations yields:

D=(t_{A}^{t}−t_{A}^{s})+(t_{B}^{t}−t_{B}^{s})+(t_{C}^{t}−t_{C}^{s})−3d Equ. 4.

The above expression can be further simplified into

D=3Ts−3d Equ. 5.

Note that at the critical point d=Ts/3, the equation yields D=2Ts.

In accordance with the present invention, there exist a simple mathematical proof that the minimum value for D for any feasible schedule is 2Ts. The proof is trivial as it takes at least 1 Ts to send and one Ts to receive one data frame; and there is no way to further shorten the period of the schedule.

Therefore, the above equation is no longer valid as d increases beyond Ts/3. A new set of equations are needed to describe the new constraining equations.

d+t_{A}^{t}=t_{B}^{s} Equ. 6;

d+t_{B}^{t}−D=t_{C}^{s} Equ. 7;

d+t_{C}^{t}=t_{A}^{s}+D Equ. 8;

The first constraining equation Equ. 6 describes the condition that the current transmission from B must start immediately after the transmission from A ends.

The second equation Equ. 7 describes the condition that the current transmission from C must start immediately after the previous transmission from B ends. This is an important observation to make. This is where the interlace plays an important role in minimizing the period D.

The third equation Equ. 8 describes the condition that the next transmission from A must start immediately after the current transmission from C ends.

Combining these equations and simplifying yields:

D=3/2(Ts+d) Equ. 9.

The above result when d=Ts/3 agrees with the previous result derived for the case when d<Ts/3.

Now, consider the case as d increases from Ts/3 to Ts. It is trivial to see that at the point d=Ts, a simple feasible schedule exist giving D=2Ts. Therefore, if one plots the graph of D as a function of d, it has a break point at d=Ts/3 where the function changes its slope from −3d to +2d, and another break point at d=Ts, where the function has a discontinuity (change from 3Ts to 2Ts). This is illustrated in FIG. 6 where in the horizontal axis is d and vertical axis is D.

The case when d>Ts has been argued to be not interesting as Ts can be adjusted to be exactly the same as d and the schedule becomes optimal. For the 3-node cycle, as d=2Ts, it is possible to schedule the transmissions without any gaps too. This case is illustrated in FIG. 10.

The 2-node case can be similarly derived. In this disclosure, only the formulas are stated (the mathematical proof is rather trivial):

If d<Ts, then D=2(Ts+d); If d=Ts, then D=2Ts.

In accordance with the present invention, a mathematical induction can be conducted to generalize the 3-node formulas to n-node cycle case. For any n-node cycles, with n>=3. the result is that: If d<[(n−2)/n] Ts, D=n(Ts−d); If [(n−2)/n] Ts<=d<Ts, then D=[n/(n−1)](Ts+d).

It is easily checked that the break points are d=[(n−2)/n] Ts and d=Ts.

It is interesting to observe that the D declines rapidly from a very long nTs to 2Ts as d increases from 0 to =[(n−2)/n] Ts; the slope of change is −n. Therefore, the delays between nodes actually help maximize throughput and minimize the period in schedule.

Note that after the break point d=[(n−2)/n] Ts is reached, the increase in D is rather slow, being n/(n−1).

The main reason for the nice result is due to the reversed path ordering. In the reversed path ordering, only one node has a forward transmission order in the sense that the out-transmission (data frame departure) occurs after the in-transmission (data frame arrival) at the node, according the base schedule. A node is said to be in reversed transmission order, if its out-transmission occurs before the in-transmission, according to the base schedule. In the 3-node case, node A and C are reversed transmission nodes, and node B is a forward transmission node. A reversed transmission node allows interlacing a base schedule with a previous base schedule, thus maximizing the overlap of time.

From the above results, it is clear that to minimize D, a best strategy is to adjust Ts so that the 1-way delay from a sender to a receiver is at either of the break points, wherein D reaches minimum (D=2Ts).

In accordance with the present invention, the general case for n-node cycle with general inter-node delay can be solved using a linear programming algorithm.

In a accordance with a preferred embodiment, a linear programming formulation is as follows:

Input to the program: the base schedule with a predefined partial order, the set of nodes and the set of transmissions.

Min D, Subject to: For each node: If the in-transmission is indexed higher (smaller number) than the out-transmission in the order, then the in-transmission must finish before the out-transmission can occur. If the out-transmission is indexed higher (smaller number) than the in-transmission in the order, then the out-transmission must finish before the in-transmission can occur.

The current out-transmission start time+D must be no earlier than latest end time of transmissions (both in- and out-) at the current node.

Note that in the above abstract description of the linear programming problem, if a transmission time (start or end) is associated with a previous or next based schedule, then D will be present in the mathematical formulas.

For example, the following linear program is given as the example for 3-node case. Assume that the delay between node A and B is denoted by d₁, the delay between node B and C is denoted by d₂, and the delay between node C and A is denoted by d₃ Min D, S.t.

t_{A}^{s}+D>=t_{C}^{t}+d₃;

t_{A}^{t}<=t_{C}^{s}+d₃

t_{B}^{t}−D<=t_{A}^{t}+d₁;

t_{B}^{s}>=t_{A}^{t}+d₁

t_{C}^{t}<=t_{B}^{s}+d₂;

t_{C}^{s}>=t_{B}^{t}−D+d₂.

An alternate way to visualize and analyze the constraining equations in a cycle is do a kinematic analysis of the data frame transmissions.

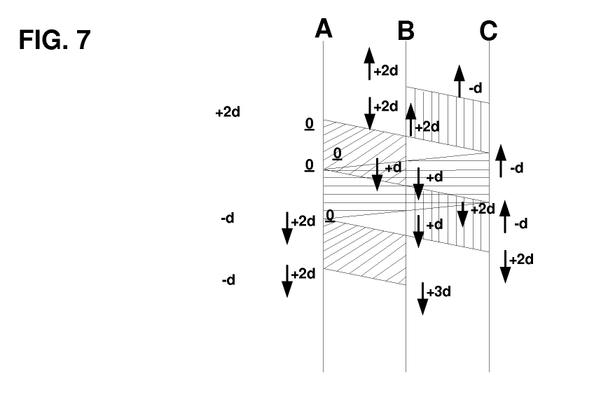

FIG. 7 presents a preferred embodiment illustrating the speed of moving of each space-time trajectory of a data frame transmission in a 3-node case.

FIGS. 8 and 9 are further examples of kinematic analysis for the 3-node case. Both examples illustrate the point that the base schedule might have to be repeated several times before the initial condition is restored. Therefore, the best way to define D is to take the average time between two consecutive transmissions from the same node.

One interesting application of the above system and method is throughput optimization in a WiFi mesh network. The system and method brings forth a few principles of design:

(1) Routing should be designed as set of cycles, and cycles can be connected by a larger cycles or ladder topology. (Cycles are needed in a mesh due to self-organizing and self-healing design objectives of mesh networks.) (2) Ordering of transmissions in a cycle should be made in the reversed path ordering. (3) Order the transmissions in the overall topology by making as much as possible reversed ordering: the out-transmissions must be ordered to occur first before the in-transmissions from the same node. This reversed ordering is a general principle to enhance interlace in a periodic schedule. It is the foundation of the reversed path ordering and is applicable not just for cycles, but also general topologies. (4) Solve the following abstract linear programming problem:

Input to the program: the base schedule with a partial order, the set of nodes and the set of transmissions.

Min D, Subject to: For each node: If an in-transmission is indexed higher (smaller number) than an out-transmission in the order, then the in-transmission must finish before the out-transmission can occur; If an out-transmission is indexed higher (smaller number) than an in-transmission in the order, then the out-transmission must finish before the in-transmission can occur; The current out-transmission start time+D must be no earlier than latest end time of transmissions (both in- and out-) at the current node.

Finally, the process can be repeated with a different partial ordering (or equivalently a different base schedule) to iteratively improve the throughput and minimize gaps.

Referring to FIG. 11, a system diagram of the present invention is shown. A hybrid WiFi/VoIP network 100 having substantially independent data path 102 and voice path 104 is provided. Hybrid WiFi/VoIP network 100 is coupled to local users including at least one local data user 106 and at least one local voice user 108. Local data user 106 may be a user who is using hybrid WiFi/VoIP network 100 to surf the Internet. Local voice user 108 may be a user using VoIP for voice communication under hybrid WiFi/VoIP network 100. Hybrid WiFi/VoIP network 100 is adapted to give priority to local voice user 108 via voice path 104 of hybrid WiFi/VoIP network 100 due to such factors as real time communication requirements of voice communications. Hybrid WiFi/VoIP network 100, in turn, is signally coupled to wide area network (WAN) 110. Wide area network (WAN) 110 is the means for coupling at least one remote end user 112 for data or voice communication with local data user 106 or local voice user 108.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A method comprising the steps of:
scheduling transmissions to minimize the average time between two consecutive transmissions from a node using linear programming.

2. The method of claim 1, wherein the scheduling step comprises WiFi scheduling.

3. The method of claim 1, wherein the scheduling step comprises periodic scheduling.

4. The method of claim 1, wherein a complete schedule is generated by repeating the base schedules for a predetermined number of times.

5. The method of claim 1, wherein when an in-transmission is indexed higher (smaller number) than the out-transmission in the order, the in-transmission must finish before an out-transmission occurs.

6. The method of claim 1, wherein when an out-transmission is indexed higher (smaller number) than an in-transmission in the order, then the out-transmission must finish before the in-transmission can occur.

7. The method of claim 1, wherein D is defined as an average time between two consecutive transmissions from a subject node.

8. The method comprising the step of providing at least three communication nodes.
